(19) United States
(12) Patent Application Publication
(10) Pub. No.: US 2009/0308576 A1
(43) Pub. Date: Dec. 17, 2009

(54) HEAT PIPE WITH A DUAL CAPILLARY STRUCTURE AND MANUFACTURING METHOD THEREOF

(76) Inventors: Cheng-Tu WANG, Taipei (TW); Pang-Hung Liao, Taipei (TW); Kuo-Feng Tseng, Taipei (TW); Chuan-Yu Lee, Taipei (TW)

Correspondence Address: HDLS Patent & Trademark Services, P.O. BOX 220746, CHANTILLY, VA, 20153-0746, US

(21) Appl. No.: 12/140,394

(22) Filed: Jun. 17, 2008

(51) Int. Cl. F28D 15/04; F22B 37/00; B23P 15/26

(52) U.S. Cl. 165/104.26; 122/366; 29/890.032

(57) ABSTRACT

A heat pipe with a dual capillary structure includes a metal tube, a first capillary, a second capillary and a working fluid. The metal tube forms a chamber and a heat-absorption part. The first capillary is formed by sintering a metal powder, and its corresponding heat-absorption part is disposed in the chamber and the second capillary is contained in the chamber and connected to an end of the first capillary. The second capillary includes an internal tube, a capillary tissue installed between inner walls of the internal tube and the metal tube, and a working fluid filled into the chamber. The invention further provides a method of manufacturing the heat pipe with a dual capillary structure.

### BACKGROUND OF THE INVENTION

1. Field of the Invention

The present invention generally relates to a heat pipe, and more particularly to a heat pipe with a dual capillary structure and a method of manufacturing the heat pipe.

2. Description of Prior Art

As the speed of a central processing unit (CPU) of a computer becomes increasingly higher, more heats are generated by a heat plate, and a traditional heat dissipating device composed of an aluminum extruded heat sink and a fan can no longer satisfy the requirements of present central processing units. Therefore, manufacturers continuously develop heat pipes with a high thermal conducting performance, and integrate the heat pipes with heat sinks to overcome the present heat dissipating issue. However, the structural design of the heat pipe and the quantity of a working fluid are related to the heat conducting speed and performance of the heat pipe. If the quantity of working fluid is too much and a gas channel in the heat pipe is reduced in size, the heat conducting performance will be affected greatly. On the other hand, if the quantity of the working fluid is too little, the interior of the heat pipe will be dried out to damage or ruin the heat pipe. Based on the aforementioned reasons, the inventor of the present invention developed a heat pipe and its manufacturing method in accordance with the present invention.

A traditional heat pipe with a dual capillary structure as disclosed in R.O.C. Publication No. 200626862 comprises a metal tube, a capillary structure and a working fluid, wherein the capillary structure comprises a plurality of meshed silk layers disposed radially along the metal tube, and the meshed silk layers include at least one flat silk net and a folded silk net disposed around the circumference of the metal tube, and the folded silk net forms a passage along its axial direction in the metal tube, and the working fluid is filled into the metal tube.

In the traditional heat pipe with a dual capillary structure, the capillary structure is formed by combining a flat silk net and a folded silk net, and there are existing problems in its practical use. Since the capillary structure is a silk net, therefore the structural strength is insufficient, and a collapse of the heat pipe usually occurs during practical operations and affects the heat conducting performance. Furthermore, these silk nets come with a rough surface, and thus causing a stopping effect to an extent regardless of a gas flow or a liquid flow. As a result, the fluid in the heat pipe cannot flow at a high speed or dissipate heat easily.

The manufacturing method of the heat pipe as disclosed in the aforementioned prior art includes the following steps of: providing at least one flat silk net and a folded sheet silk net; coiling the silk net layer by layer into a cylindrical body; and placing the cylindrical body into the metal tube. Since the external diameter of a general heat pipe is not too large, it is not easy to install the silk net type capillary structure into the metal tube, and it is even more difficult to manufacture the heat pipe by combining and attaching the capillary structure with the internal wall of the metal tube. In the aforementioned traditional method, the yield rate of the heat pipe is poor and such method definitely requires improvements.

In view of the shortcomings of the prior art, the inventor of the present invention based on years of experience in the related industry to conduct extensive researches and experiments, and finally developed a heat pipe with a dual capillary structure and its manufacturing method in accordance with the present invention.

### SUMMARY OF THE INVENTION

It is a primary objective of the present invention to overcome the foregoing shortcomings by providing a heat pipe with a dual capillary structure and its manufacturing method, and a dense capillary structure is formed in a heat-absorption part of the metal tube, and an internal tube and a channel with a large containing space are formed in the remaining portion of the metal tube, not only avoiding the dry-out phenomenon of the heat pipe, but also providing a better structural strength to prevent a collapse of the capillary structure effectively, enhancing the heat conducting speed and performance of the heat pipe, and improving the yield rate of the heat pipe.

To achieve the foregoing objective, the present invention provides a heat pipe with a dual capillary structure, comprising a metal tube, a heat-absorption part, a first capillary, a second capillary and a working fluid. The metal tube forms a chamber and the heat-absorption part is formed at a section of the metal tube, and the first capillary is formed by sintering a metal powder and disposed corresponding to the heat-absorption part in the chamber. The second capillary is contained in the chamber and connected to an end of the first capillary, and includes an internal tube and a capillary tissue disposed between the internal tube and the internal wall of the metal tube. The working fluid is filled into the chamber.

To achieve the foregoing objectives, the present invention provides a method of manufacturing a heat pipe with a dual capillary structure, comprising the steps of:

(a) providing a metal tube;

(b) inserting a core rod into the metal tube, and forming a gap between the external periphery of the core rod and the internal wall of the metal tube;

(c) filling a metal powder in the gap;

(d) heating and sintering the metal powder to form a first capillary in the metal tube;

(e) removing the core rod;

(f) providing a second capillary;

(g) placing the second capillary into the metal tube, and connecting the second capillary to an end of the first capillary; and

(h) filling a working fluid into the metal tube, and removing air and sealing an opening of the metal tube.

### BRIEF DESCRIPTION OF DRAWINGS

FIG. 1 is a cross-sectional view of a heat pipe in accordance with the present invention;

FIG. 2 is a cross-sectional view of Section 2-2 of FIG. 1;

FIG. 3 is a cross-sectional view of Section 3-3 of FIG. 1;

FIG. 4 is a flow chart of manufacturing a heat pipe in accordance with the present invention;

FIG. 5 is a cross-sectional view of a core rod inserted into a metal tube in accordance with the present invention;

FIG. 6 is a cross-sectional view of a metal powder filled in a metal tube in accordance with the present invention;

FIG. 7 is an exploded view of a second capillary without installing a metal tube in accordance with the present invention;

FIG. 8 is cross-sectional view of a portion of a heat pipe in accordance with the present invention:

FIG. 9 is a schematic view of an electronic heat-generating component applied to a heat pipe in accordance with the present invention; and

FIG. 10 is a schematic view of a heat pipe in accordance with another preferred embodiment of the present invention.

### DETAILED DESCRIPTION OF THE INVENTION

The technical characteristics, features and advantages of the present invention will become apparent in the following detailed description of preferred embodiments with reference to the accompanying drawings, and the preferred embodiments are used for illustrating the present invention only, but not intended to limit the scope of the present invention.

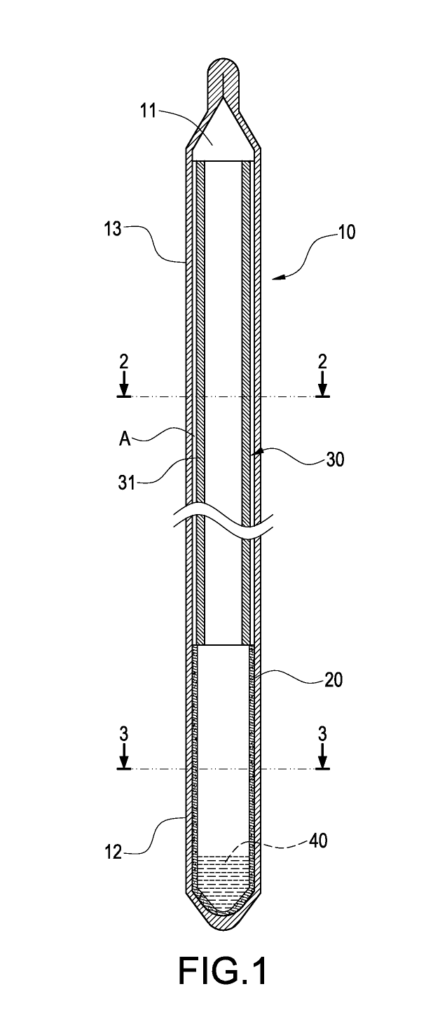

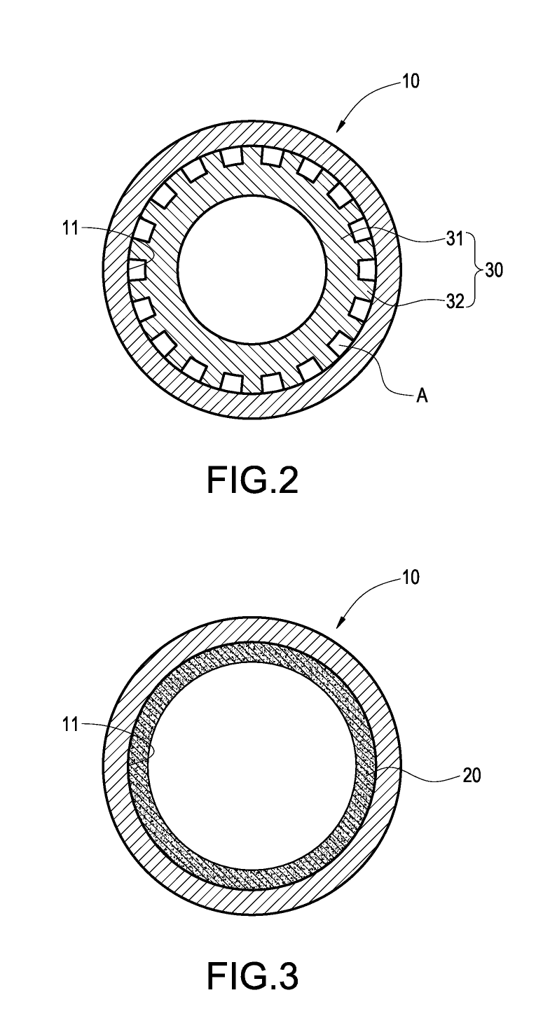

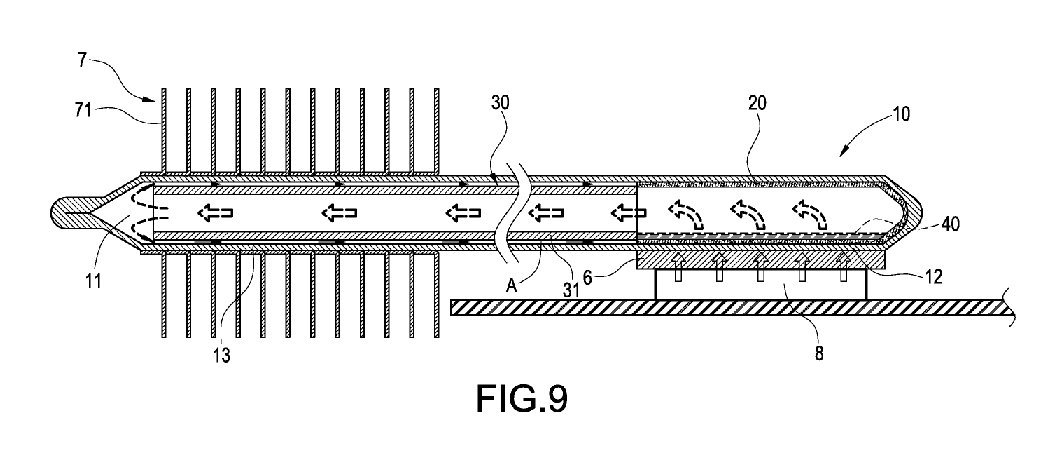

Referring to FIGS. 1 to 3 for a cross-sectional view of a heat pipe of the present, a cross-sectional view of Section 2-2 of FIG. 1 and a cross-sectional view of Section 3-3 of FIG. 1 respectively, the present invention provides a heat pipe with a dual capillary structure comprises a metal tube 10, a heat-absorption part 12, a heat-dissipation part 13, a first capillary 20, a second capillary 30 and a working fluid 40. The metal tube 10 includes a chamber 11 therein, the heat-absorption part 12 formed at the bottom section of the metal tube 10, and the heat-dissipation part 13 formed at the top section of the metal tube 10, wherein the heat-absorption part 12 is attached with an electronic heat-generating component 8 (as shown in FIG. 9), and the heat-dissipation part 13 is provided for coupling the heat dissipating fins module 7 (as shown in FIG. 9). The first capillary 20 is formed by sintering a metal powder and disposed corresponding to the heat-absorption part 12 in the chamber 11. The second capillary 30 includes an internal tube 31 and a capillary tissue disposed between the internal tube 31 and the internal wall of the metal tube 10, and the internal wall of the internal tube 31 is a smooth surface. The capillary tissue of this preferred embodiment comprises a plurality of protruding bars 32 extended from the external periphery of the internal tube 31, and a channel A formed between any two adjacent protruding bars 32, and the protruding bars 32 are parallel to the axial line of the internal tube 31. The second capillary 30 is disposed in the chamber 11 of the metal tube 10 and attached to an end of the first capillary 20, and the axial line of the internal tube 31 is parallel to the axial line of the metal tube 10, and a working fluid 40 is filled into the chamber 11.

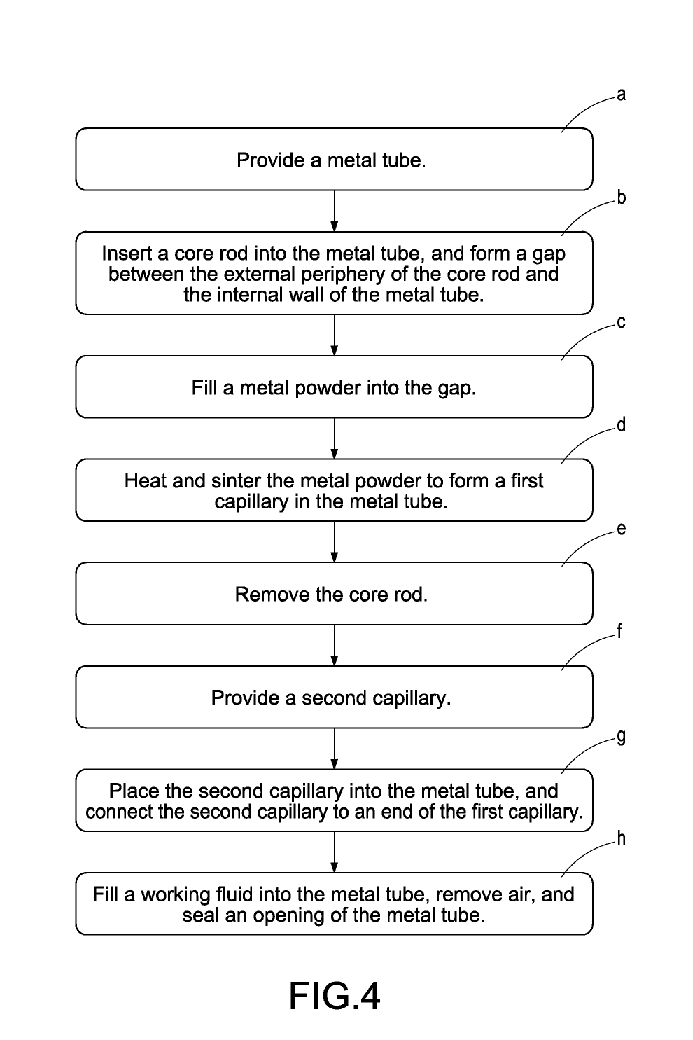

Referring to FIGS. 4 to 8 for a flow chart of a method of manufacturing a heat pipe and cross-sectional views of a heat pipe in accordance with the present invention, the method comprises the following steps:

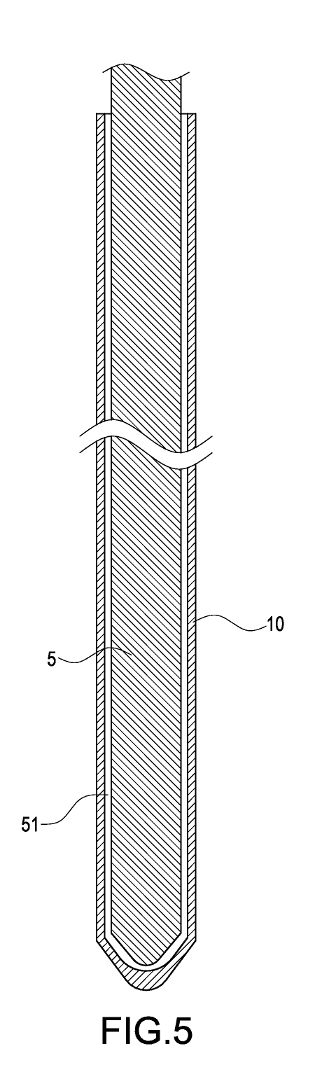

(a) Provide a metal tube 10 (as shown in FIG. 5), wherein the metal tube 10 of this preferred embodiment is made of a good thermal conducting and heat dissipating material such as copper, and the metal tube 10 is in a circular shape or any other geometric shape, and the internal wall of the metal tube 10 is a smooth surface, and the bottom end of the metal tube 10 is manufactured into a tapered shape by a shaping tool (not shown in the figure) or soldered and sealed by a soldering device (not shown in the figure).

(b) Insert a core rod 5 into the metal tube 10, and form a gap 51 between the external periphery of the core rod 5 and the internal wall of the metal tube 10 (as shown in FIG. 5). In this step, the core rod 5 having an external diameter smaller than the internal diameter of the metal tube 10 is inserted into the metal tube 10, such that a gap 51 is formed between the external periphery of the core rod 5 and the internal wall of the metal tube 10.

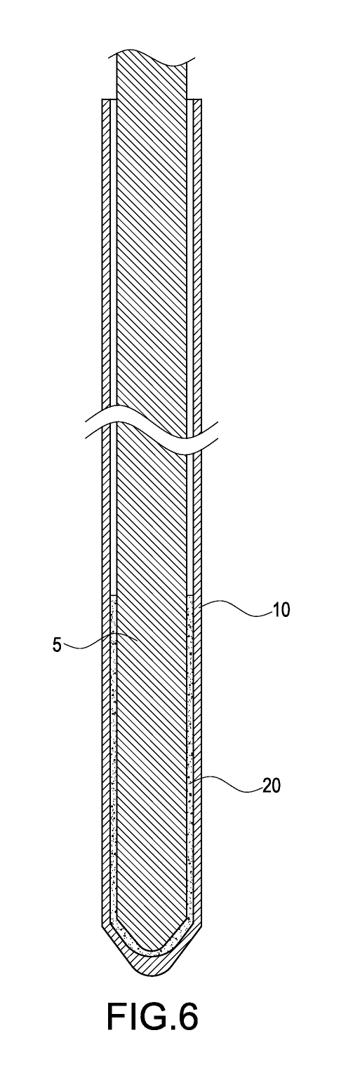

(c) Fill a metal powder in the gap 51 (as shown in FIG. 6). In this step, the filled quantity of the metal powder is smaller than half of the volume of the gap 51, and the area filled with the metal powder is exactly a heat-absorption part 12 of the heat pipe. In this preferred embodiment, the metal powder is filled to a height of the metal tube 10 slightly greater than the length of the heat-absorption part 12.

(d) Heat and sinter the metal powder to form a first capillary 20 in the metal tube 10, wherein the circular first capillary 20 is formed on the internal wall and at a bottom position of the metal tube 10 by the filled metal powder by a sintering process.

(e) Remove the core rod 5. In this step, the core rod 5 is shaken sideway to loosen the first capillary 20 and the core rod 5, and then the core rod 5 is removed from the metal tube 10 to form a hollow in the heat-absorption part 12.

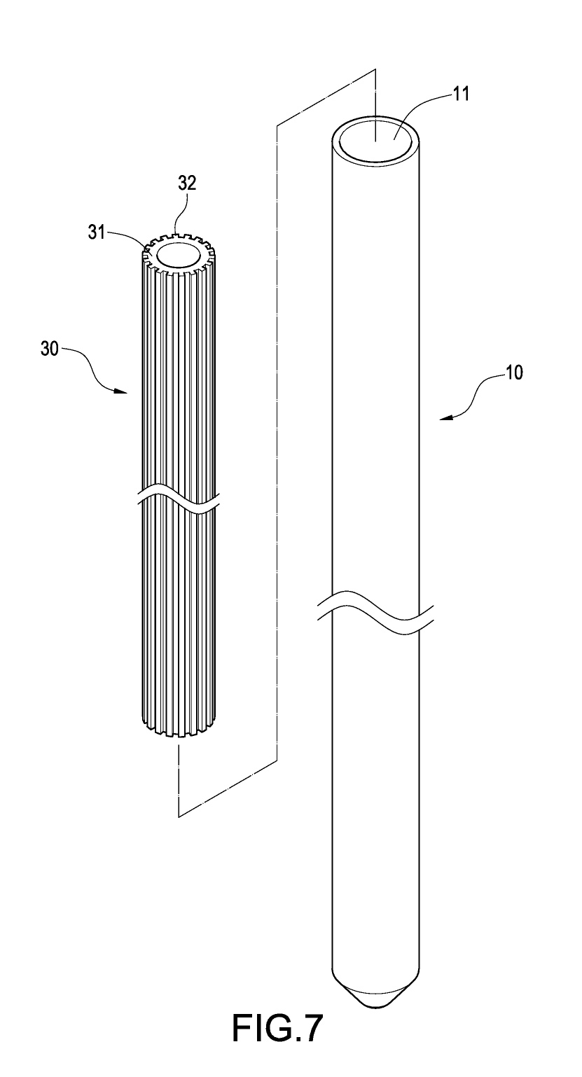

(f) Provide a second capillary 30 (as shown in FIG. 7). In this step, the second capillary 30 includes an internal tube 31 and a capillary tissue disposed between the internal tube 31 and the internal wall of the metal tube 10. In this preferred embodiment, the capillary tissue is comprised of a plurality of protruding bars 32 extended from the external periphery of the internal tube 31 and a channel A formed between any two adjacent protruding bars 32.

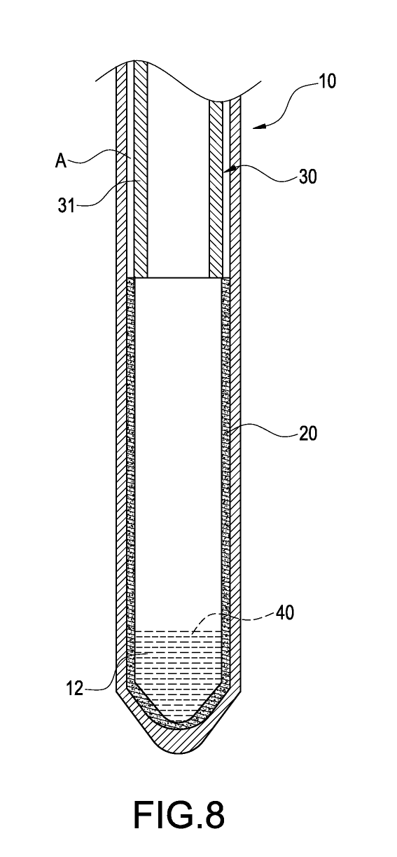

(g) Place the second capillary 30 into the metal tube 10, and connect the second capillary 30 with an end of the first capillary 20. In this step, the second capillary 30 is passed into the metal tube 10, and the bottom end of the second capillary 30 is attached with the top end of the first capillary 20 (as shown in FIG. 8).

(h) Fill a working fluid 40 into the metal tube 10, remove air in the metal tube 10, and seal the metal tube 1O. In this step, the metal tube 10 is erected or inclined, and then a working fluid 40 such as pure water is filled into the chamber 11 of the metal tube 10 (as shown in FIG. 8). An air removing device is heated to discharge any gas remained in the metal tube 10, and finally an open end of the metal tube 10 is sealed.

Referring to FIG. 9 for a schematic view of an electronic heat-generating component applied to a heat pipe in accordance with the present invention, the heat-dissipation part 13 is provided for sheathing a heat dissipating fins module 7, and the heat dissipating fins module 7 is formed by stacking and connecting a plurality of fins 71, and the heat-absorption part 12 is attached to an electronic heat-generating component 8 through a heat plate 6. A large quantity of heat is produced during the operation of the electronic heat-generating component 8, and such heat will vaporize the working fluid 40, and a latent heat is produced by a phase change of the vaporized fluid will dissipate a large quantity of heat, and the heat is moved at a high speed from the heat-absorption part 12 to the heat-dissipation part 13 along the central position of the internal tube 31 of the second capillary 30. The heat dissipation effect provided by the heat dissipating fins module 7 results in a condensation of the vaporized fluid into a liquid. The liquid flows back to the first capillary 20 through each channel A by means of the pressure difference effect of the gas or the gravitational effect. With the capillary action of the first capillary 20, the condensed liquid returns to an end where the heat pipe is attached with the electronic heat-generating component 8, so as to constitute a continuous circulation of the heat pipe.

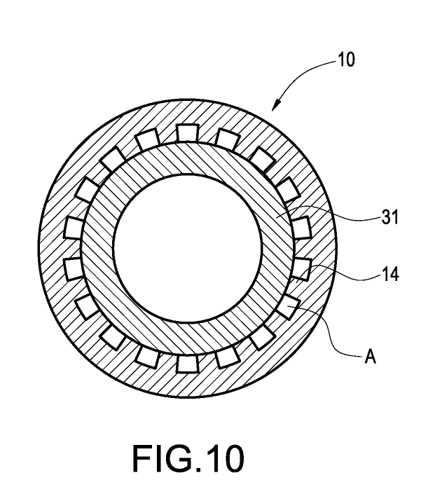

Referring to FIG. 10 for a cross-sectional view of a heat pipe in accordance with another preferred embodiment of the present invention, the capillary tissue of the second capillary 30 of the heat pipe is comprised of a plurality of partition bars 14 extended from the internal wall of the metal tube 10 and a channel A formed between any two adjacent partition bars 14 to provide an equivalent effect of the first preferred embodiment.

In summation of the description above, the heat pipe with a dual capillary structure and its manufacturing method in accordance with the present invention complies with the patent application requirements and thus is duly filed for patent application.

While the invention is described in by way of examples and in terms of preferred embodiments, it is to be understood that the invention is not limited thereto. On the contrary, the aim is to cover all modifications, alternatives and equivalents falling within the spirit and scope of the invention as defined by the appended claims.

What is claimed is:

1. A heat pipe with a dual capillary structure, comprising:
a metal tube, having a chamber formed therein;
a heat-absorption part, formed at a section of the metal tube;
a first capillary, formed by sintering a metal powder, and disposed corresponding to the heat-absorption part in the chamber;
a second capillary, contained in the chamber, and coupled to an end of the first capillary, and the second capillary having an internal tube and a capillary tissue disposed between the internal tube and the internal wall of the metal tube; and
a working fluid, filled into the chamber.

2. The heat pipe with a dual capillary structure of claim 1, wherein the capillary tissue is comprised of a plurality of partition bars extended from the external periphery of the internal tube and a channel formed between any two adjacent partition bars.

3. The heat pipe with a dual capillary structure of claim 1, wherein the capillary tissue is comprised of a plurality of partition bars extended from the internal wall of the metal tube and a channel formed between any two adjacent partition bars.

4. The heat pipe with a dual capillary structure of claim 1, wherein the internal tube has an axial line parallel with the axial line of the metal tube.

5. The heat pipe with a dual capillary structure of claim 1, wherein the internal wall of the internal tube is a smooth surface.

6. The heat pipe with a dual capillary structure, further comprising a heat-dissipation part, and the heat-dissipation part is formed at another section of the metal tube away from the heat-absorption part.

7. A method of manufacturing a heat pipe with a dual capillary structure, comprising the steps of:
(a) providing a metal tube;
(b) inserting a core rod into the metal tube, wherein a gap is formed between the external periphery of the core rod and the internal wall of the metal tube;
(c) filling a metal powder into the gap;
(d) heating and sintering the metal powder to form a first capillary in the metal tube;
(e) removing the core rod;
(f) providing a second capillary;
(g) placing the second capillary into the metal tube, and connecting the second capillary to an end of the first capillary; and
(h) filling a working fluid into the metal tube, removing air, and sealing an opening of the metal tube.

8. The method of manufacturing a heat pipe with a dual capillary structure of claim 7, wherein the metal tube in the step (a) has an end manufactured into a tapered shape.

9. The method of manufacturing a heat pipe with a dual capillary structure of claim 7, wherein the metal tube in the step (a) has an end sealed and manufactured by a soldering method.

10. The method of manufacturing a heat pipe with a dual capillary structure of claim 7, wherein the metal powder in the step (c) is filled with a quantity smaller than one-half of the volume of the gap, and an area for filling in the metal powder is formed as a heat-absorption part of the heat pipe.

11. The method of manufacturing a heat pipe with a dual capillary structure of claim 10, wherein the metal powder in the step (c) is filled to a height of the metal tube greater than the length of the heat-absorption part.

12. The method of manufacturing a heat pipe with a dual capillary structure of claim 7, wherein the second capillary in the step (f) comprises an internal tube and a capillary tissue disposed between the internal tube and the internal wall of the metal tube.
